(19) United States
(12) Patent Application Publication
(10) Pub. No.: US 2002/0169011 A1
(43) Pub. Date: Nov. 14, 2002

(54) Flail straw chopper blade

(76) Inventor: John Edward Wilson, Coal Valley, IL (US)

Correspondence Address: Deere & Company, One John Deere Place, Moline, IL, 61265-8098, US

(21) Appl. No.: 09/851,827

(22) Filed: May 9, 2001

(51) Int. Cl. A01D 34/42; A01F 12/40

(52) U.S. Cl. 460/111; 460/112; 56/505

(57) ABSTRACT

A flail chopper blade comprises an integral cast body that is reversible. Each flail chopper blade is provided with a mounting end and a crop processing end. The mounting end is provided with an outwardly extending radial slot defining two transverse mounting bores. The crop processing end is provided with two hammers that are separated from one another by an inwardly extending slot. The mounting end and the crop processing end are coupled to one another by a middle flange portion. The middle flange portion has a reinforcing ridge that defines a portion of the inwardly extending radial slot and the outwardly extending radial slot.

### BACKGROUND OF THE INVENTION

1. Field of the Invention:

The present invention is directed to a reversible cast flail straw chopper blade having a crop processing end with hammers and an inwardly extending radial slot through which passes a stationary blade.

2. Description of the Prior Art:

Combines are large agricultural machines used to harvest, thresh, separate and clean an agricultural crop. Combines are provided with a grain tank for temporarily storing clean grain before it is unloaded to a grain cart or truck by an unloading auger. These machines are usually self propelled and may be provided with additional crop processing assemblies like straw choppers and chaff spreaders.

Straw choppers receive residue crop material from the separating system of the combine. The straw chopper reduces the size of the crop material components before directing the crop material back to the field. Typically straw choppers are equipped with a casing housing a rotor. Stationary knives project inwardly from the casing and cooperate with flail chopper blades to chop the crop material. Some blades are equipped with transverse paddles, see U.S. Pat. Nos. 5,232,405 and 5,482,508.

### SUMMARY

It is an object of the present invention to provide a straw chopper for a combine having improved flail chopper blades.

The straw chopper comprises a casing having a plurality of inwardly extending knives. A rotor is rotationally mounted in the casing and is provided with a plurality of flail chopper blades. The flail chopper blades are pivotally mounted to the casing on radially extending mounting plates. Each of the flail chopper blades is provided with a first end forming a mounting end that is pivotally coupled to one of the radially extending mounting plates. The mounting end is provided with an outwardly extending radial slot defining two transverse mounting bores. The radially extending mounting plate is received in the outwardly extending radial slot. The flail chopper blades are provided with a crop-processing end having two hammers that are separated from one another by an inwardly extending slot. As the rotor is rotated, both side walls of the crop processing end and the inwardly extending slot pass by the stationary knives. The mounting end and the crop processing end are coupled to one another by a middle flange portion. The middle flange portion has a reinforcing ridge that defines a portion of the inwardly extending radial slot and the outwardly extending radial slot.

Each flail chopper blade is an integral cast part having a front side and a rear side. Both the front side and the rear side are identical making the flail chopper blade reversible. In this way the blades can be reversed to even out wear between the front side and the back side. In addition by concentrating more mass in the hammers of the crop processing end there is more sacrificial mass to wear. The shape of the blade optimizes the transfer of impact energy for pulverizing crop material while increasing wear life. In addition, the flat shape of the blade increases air velocity through the chopper facilitating the spread of crop residue.

### BRIEF DESCRIPTION OF THE DRAWINGS

FIG. 1 is a semi-schematic side view of a combine.

FIG. 2 is a perspective view of the straw chopper rotor.

FIG. 3 is a perspective view of a flail chopper blade of the present invention.

### DETAILED DESCRIPTION

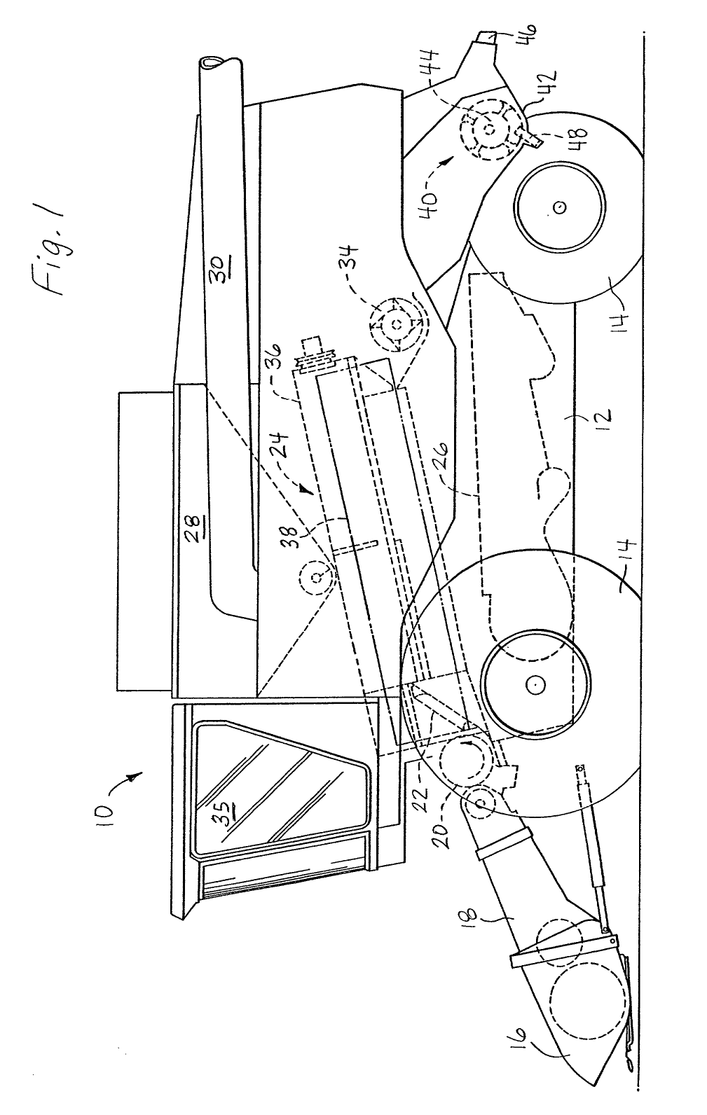

FIG. 1 shows an agricultural combine 10 comprising a supporting structure 12 having ground engaging wheels 14 extending from the supporting structure. Although the combine is illustrated as having wheels, it could also have ground engaging tracks, either full tracks or half tracks. A harvesting platform 16 is used for harvesting a crop and directing it to a feederhouse 18. The harvested crop is directed by the feederhouse 18 to a beater 20. The beater directs the crop upwardly through an inlet transition section 22 to the axial crop-processing unit 24.

The crop-processing unit threshes and separates the harvested crop material. Grain and chaff fall through grates on the bottom of the unit 24 to cleaning system 26. The cleaning system 26 removes the chaff and directs the clean grain to a clean grain elevator (not shown). The clean grain elevator deposits the clean grain in grain tank 28. The clean grain in the tank can be unloaded into a grain cart or truck by unloading auger 30.

Threshed and separated straw is discharged from the axial crop-processing unit through outlet 32 to discharge beater 34. The discharge beater in turn propels the crop material other than grain directly to a straw chopper 40. The operation of the combine is controlled from operator's cab 35.

The axial crop-processing unit comprises a cylindrical rotor housing 36 and a rotor 38 located inside the housing 36. The front part of the rotor and the rotor housing define the infeed section of the crop-processing unit 24. Longitudinally downstream from the infeed section are a threshing section, a separating section and a discharge section. The rotor 38 in the infeed section is provided with a conical rotor drum having helical infeed elements for engaging harvested crop material received from the beater 20 and inlet transition section 22. Immediately downstream from the infeed section is the threshing section of the crop-processing unit 24. In the threshing section the rotor 38 comprises a cylindrical rotor drum having a number of threshing elements for threshing the harvested crop material received from the infeed section. Downstream from the threshing section is the separating section, wherein the grain trapped in the threshed crop material is released and falls through a floor grate to the cleaning system 28. The separating section merges into a discharge section, where crop material other than grain is expelled from the axial crop-processing unit 24.

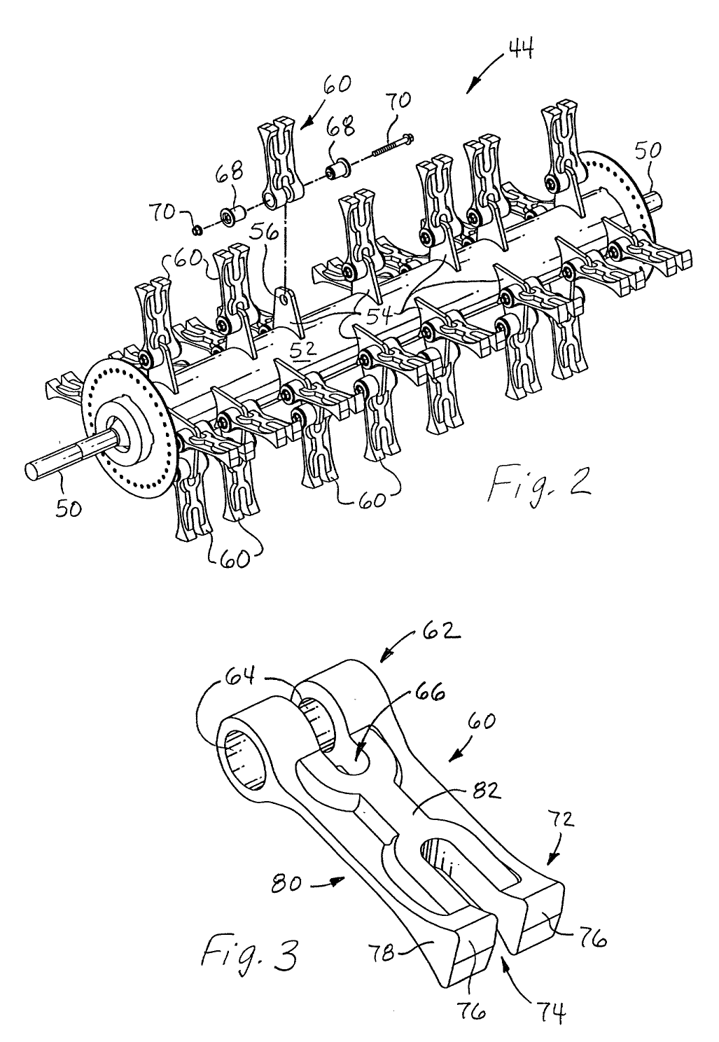

The straw chopper 40 comprises a casing 42 and a rotor 44 rotationally mounted in the casing. The chopped crop material other than grain is dispersed to the field by guide vanes 46. The casing is provided with a plurality of inwardly extending stationary knives 48. The rotor 44, best illustrated in FIG. 2, comprises a drive shaft 50 that is coupled to a cylindrical tube 52. The cylindrical tube 52 is provided with a plurality of radially extending mounting plates 54. Each of the mounting plates 54 is provided with a mounting aperture 56.

A plurality of flail chopper blades 60 are pivotally mounted to the mounting plates 54. Each of the flail chopper blades 60 is provided with a first end 62 having two mounting bores 64 separated by an outwardly extending radial slot 66 corresponding to the respective mounting plate 54. Each flail chopper blade 60 is pivotally mounted to the mounting plate 54 by two bushings 68 that are coupled to the mounting plate 54 by mounting bolt and nut 70. The first end 62 is the mounting end of each blade 60.

Each flail chopper blade 60 is provided with a second end 72 having an inwardly extending radial slot 74. The second end 72 is the crop processing end of the blade first encountering the crop mat. The second end 72 is enlarged in the circumferential direction to form two hammers 76. These hammers 76 locate more blade mass at the crop processing end of the blade to better pulverize crop material. In addition, there is more sacrificial mass to wear at the crop processing end by these enlarged hammers 76. The flail chopper blades are rotated on rotor 44 and rotate past stationary knives 48. The stationary knives 48 pass through slot 74 and along the side walls 78 of the blades 60.

A middle flange portion 80 extends between the first end 62 and the second end 72. The middle flange portion 80 has a reinforcing ridge 82 extending between the first and second ends 62 and 72 defining the edges of the slots 66 and 74.

The flail chopper blade 60 is reversible so that left and right blades are not required. In addition, when one side of the blade becomes worn, the blade can be reversed to allocate blade wear to both sides. In the preferred illustrated embodiment the blade is cast.

The present invention should not be limited to the above described embodiment, but should be limited solely by the claims that follow:

I claim:

1. A straw chopper for an agricultural combine, the straw chopper comprising:
a casing having a plurality of inwardly extending stationary knife blades;
a rotor being rotationally mounted in the casing and rotating in a circumferential direction;
a plurality of flail chopper blades, each flail chopper blade has a first end that is pivotally coupled to the rotor and a second end having an inwardly extending slot corresponding to one of the plurality of inwardly extending stationary knife blades.

2. A straw chopper as defined by claim 1 wherein the second end of each flail chopper blade is enlarged in the circumferential direction.

3. A straw chopper as defined by claim 1 wherein each flail chopper blade is provided with a middle flange portion extending between the first and second ends, the middle flange portion being thinner in the circumferential direction that the second end.

4. A straw chopper as defined by claim 3 wherein the first end is provided with two transverse bores that are separated from one another by an outwardly extending radial slot.

5. A straw chopper as defined by claim 4 wherein the middle flange portion is provided with a reinforcing ridge that also defines a portion of the inwardly extending radial slot and a portion of the outwardly extending radial slot.

6. A straw chopper as defined by claim 5 wherein each flail chopper blade is reversible having a front side and a rear side that are identical to one another.

7. A flail chopper blade comprising:
a mounting end having at least one mounting bore for pivotally mounting said flail chopper blade to a rotor;
a crop processing end having an inwardly extending radial slot, two thickened hammers are formed on either side of the inwardly extending radial slot; and
a middle flange portion extending between the mounting and crop processing ends, the first and second ends and the middle flange portion being one integral body.

8. A flail chopper blade as defined by claim 7 wherein said flail chopper blade has a front side and a rear side that are identical to one another making the flail chopper blade reversible.

9. A flail chopper blade as defined by claim 8 wherein the mounting end is provided with an outwardly extending radial slot separating two transverse mounting bores.

10. A flail chopper blade as defined by claim 9 wherein the middle flange portion is provided with a reinforcing ridge that also defines a portion of the inwardly extending radial slot and a portion of the outwardly extending radial slot.

11. A flail chopper blade comprising:
a mounting end for pivotally mounting said flail chopper blade to a rotor;
a crop processing end having an inwardly extending radial slot; and
a middle flange portion extending between the mounting and crop processing ends, said flail chopper blade having a front side and a rear side that are identical to one another making the flail chopper blade reversible.

12. A flail chopper blade as defined by claim 11 wherein the mounting and crop processing ends and the middle flange portion are one integral cast body.

13. A flail chopper as defined by claim 12 wherein the mounting end is provided with an outwardly extending radial slot that separates two mounting bores for pivotally mounting said flail chopper blade to a rotor.

14. A flail chopper blade as defined by claim 13 wherein the crop processing end is provided with an inwardly extending radial slot separating two hammers.

15. A flail chopper blade as defined by claim 14 wherein the middle flange portion is provided with a reinforcing ridge that also defines a portion of the inwardly extending radial slot and a portion of the outwardly extending radial slot.
